(19) United States
(12) Patent Application Publication
(10) Pub. No.: US 2005/0253700 A1
(43) Pub. Date: Nov. 17, 2005

(54) Machine designed for a means of monitoring a motor vehicle operators actions and reactions to driving condition as they drive and alert other drivers behind them of their actions such as braking, coasting and accelerating. Compiled data will be displayed with a rear lighting device. (Smart Light)

(76) Inventor: David Anthony Keena, Sterling Heights, MI (US)

Correspondence Address: David Anthony Keena, 39664 Ryan Rd, Sterling Heights, MI, 48310, US

(21) Appl. No.: 11/126,188

(22) Filed: May 11, 2005

Related U.S. Application Data
(60) Provisional application No. 60/570,959, filed on May 14, 2004.

(51) Int. Cl. B60Q 1/50

(52) U.S. Cl. 340/464; 340/576

(57) ABSTRACT

A machine for monitoring a motor vehicle operators actions and reactions to driving condition as they drive and alert other drivers behind them of their braking, coasting and accelerating actions with a multi function lighting device with A computerized light control module that will analyze information from the vehicles on board factory or added computer and/or mechanical system and display it's information in a lighted form on the rear of the motor vehicle with A multi function light output source that that can receive the gathered data and display it in a lighted way to inform other drivers of the drivers action and/or reactions to certain driving conditions, example: (bright green, green, amber, red, bright red, pulsating red) when signaled from the light control module.

### CROSS REFERENCE TO RELATED APPLICATIONS

This application is based on provisional application Ser. No. 60/570,959, filed on May 14, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Motor Vehicle safety and more specifically to a machine for monitoring a motor vehicle operators actions and reactions to driving condition as they drive and alert other drivers behind them of their braking, coasting and accelerating actions with a lighting device.

The traditional motor vehicle rear lighted warning system (brake light) only produces an on and off red light. This new system will do what traditional brake light systems do or in conjunction with it plus may alert other drivers that the vehicle is coasting and may brake at any time, coasting and may accelerate at any time, braking, braking hard or with anti lock braking system engaged, accelerating or accelerating fast. Persons driving behind a motor vehicle with this operating system will be able to mentally gather the information outputted from the light source prior to an action from the driver and be mentally ready to brake or accelerate themselves prior to any actual action from the forward operators.

Prior technology of a motor vehicles rear lighted warning system, (brake light) is comprised of a single lamp on each side of the vehicles rear section which goes on and off when the vehicles braking system is activated.

Prior technology of the traditional brake light can only distinguish between braking and not braking, on or off. Old technology does not have the multi function output capabilities of this new alert system.

### BRIEF SUMMARY OF THE INVENTION

The primary object of the invention is To provide means of collecting data from the vehicles on board or added electrical and mechanical systems and display it in the form of a multi function rear lighting system for a better lighted rear warning system on motor vehicles. One way would be to have a red light for braking an amber light for coasting and a green light for accelerating with the brightness intensifying or pulsating with acceleration or braking.

Another object of the invention is To provide a means to add an additional lighting system to alert other drivers besides the traditional brake light system which only has an off and on switch.

Another object of the invention is To provide a means of displaying the collected data on the rear of a vehicle in the form of a multi function lighting device).

A further object of the invention is To provide a safer driving experience to the general public by way of informing other drivers of your actions and responses to certain driving conditions as they happen.

Yet another object of the invention is To provide a system that can be integrated and developed for use on any vehicle manufacturers factory on board electrical, computer system and mechanical system.

Still yet another object of the invention is To provide a multi function brake light system.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for monitoring a motor vehicle operators actions and reactions to driving condition as they drive and alert other drivers behind them of their braking, coasting and accelerating actions with a multi function lighting device. Comprising: A computerized light control module that will analyze information from the on board factory computer, mechanical system and display it's information in a lighted form on the rear of the motor vehicle, and A light output source that may change color and intensity, (example: bright green, green, amber, red, bright red,) when signaled from the light control module.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart of the invention.

FIG. 2 is a flow chart of the operations that comprise the method.

FIG. 3 is an elevational view of the invention and the rear some light placement options.

FIG. 4 is a flow chart of the operations that comprise the method.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The common traditional brake light system is comprised of a brake pedal that engages or disengages a switch that powers rear brake lights on and off. This system has been in operation since the early 1900's without change. The purpose of the SMART LIGHT is to add additional information for other drivers to comprehend, analyze and react too.

This information will be collected from the vehicles on board electrical, computer, mechanical systems and the vehicles sensors and sent too and analyzed by the light control module and be transformed in conjunction or separate with the traditional brake light system in the form of colored lighting (example, bright green, green, amber, red, bright red, pulsating red) to a rear lighting system to alert other drivers of impending actions of the driver.

To provide a better brake light warning system on motor vehicles

To provide an additional lighting system to alert drivers besides the traditional brake light system which only has an off and on switch.

To provide a light to alert other drivers you are coasting, (neither braking or accelerating).

To provide a light to alert other drivers you are accelerating.

To provide an additional or brighter light to alert other drivers you are accelerating fast.

To provide an additional light to alert other drivers you are braking normal.

To provide an additional or brighter light to alert other drivers you are braking hard.

To provide an additional pulsating light to alert other drivers you are braking and you're anti lock brake system has been activated.

To provide a safer driving experience to the general public by way of informing other drivers of your actions and responses to certain driving conditions as they happen.

To provide a system that can be integrated and developed for use on any vehicle manufacturers factory on board computer electrical and mechanical system.

To provide a multi function brake light system.

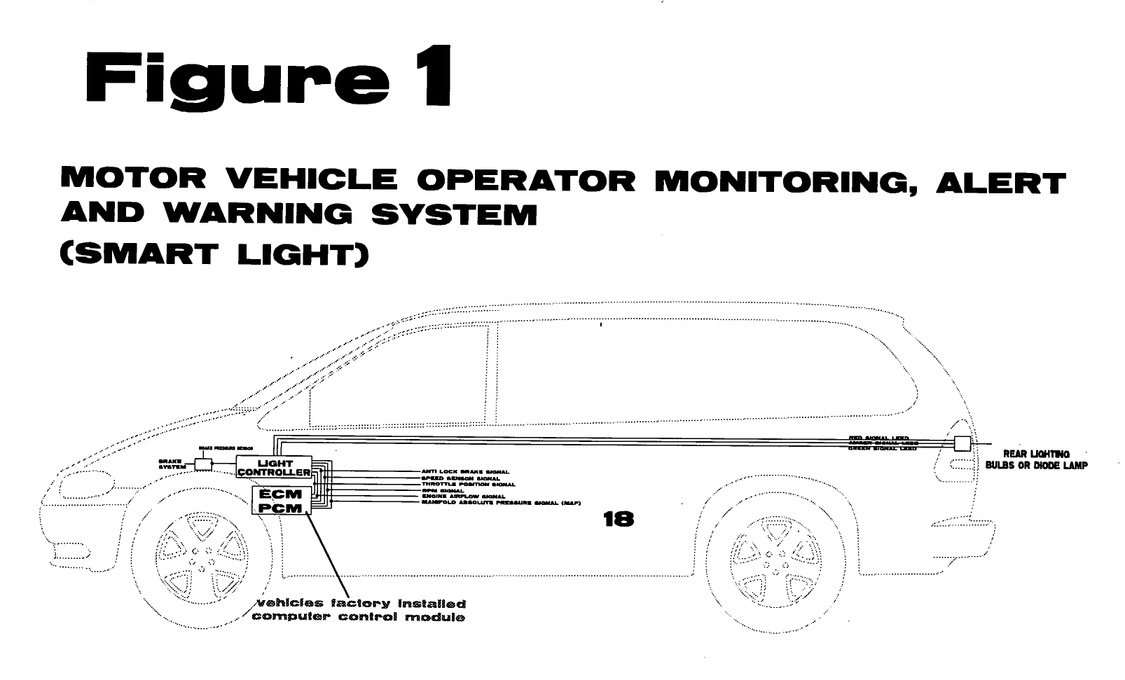

Turning first to FIG. 1 there is shown an expanded view of the basic of the system and how it may be integrated into a motor vehicle electronic computer system.

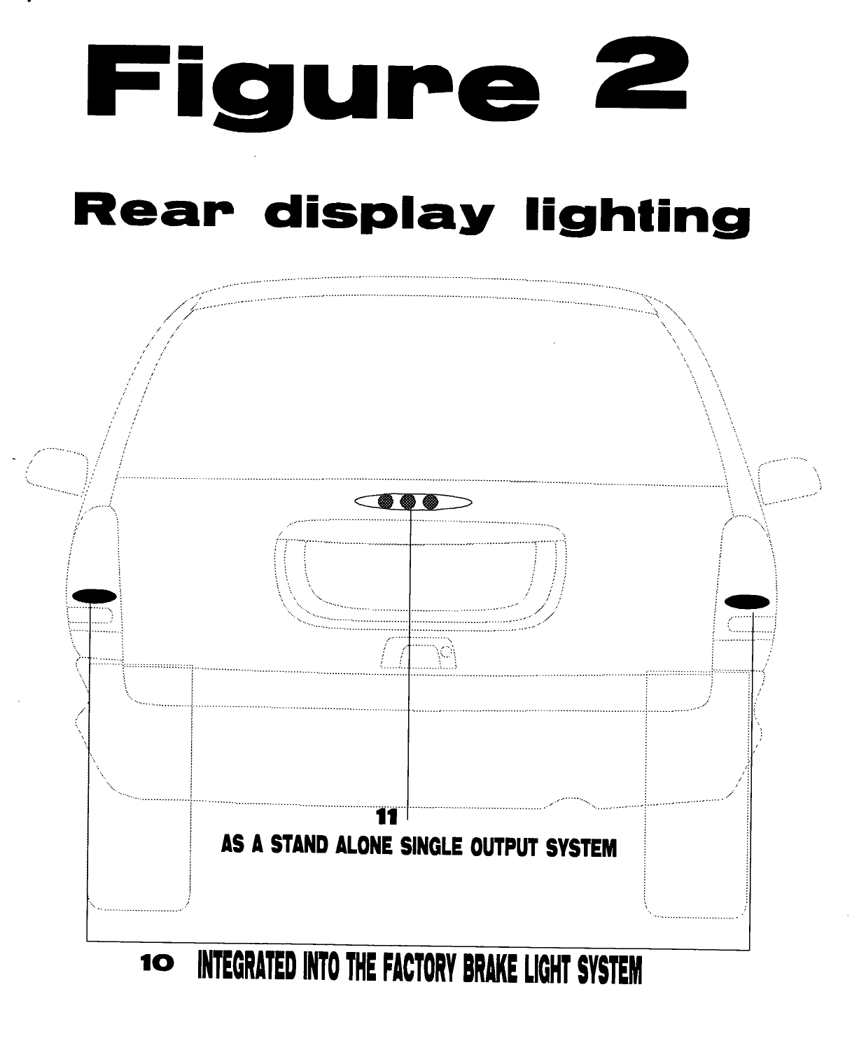

Turning to FIG. 2-10 it is shown the inventions output light system integrated into the factory tail light system.

Turning to FIGS. 2-11 it is shown a single stand-alone output light system.

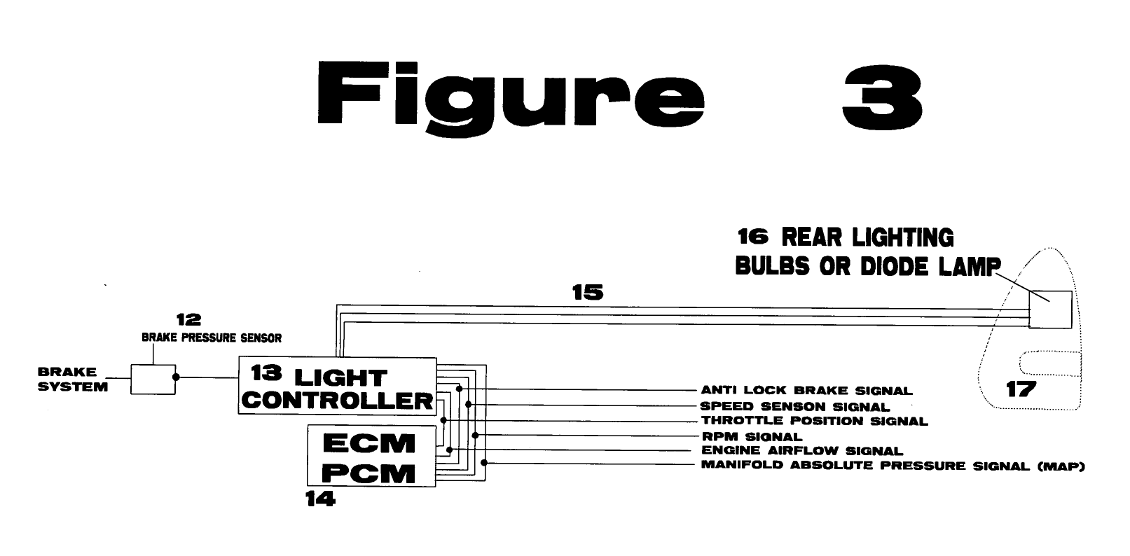

Turning to FIG. 3 it is shown a basic flow chart on how the invention may be integrated into a motor vehicles electronic computer system.

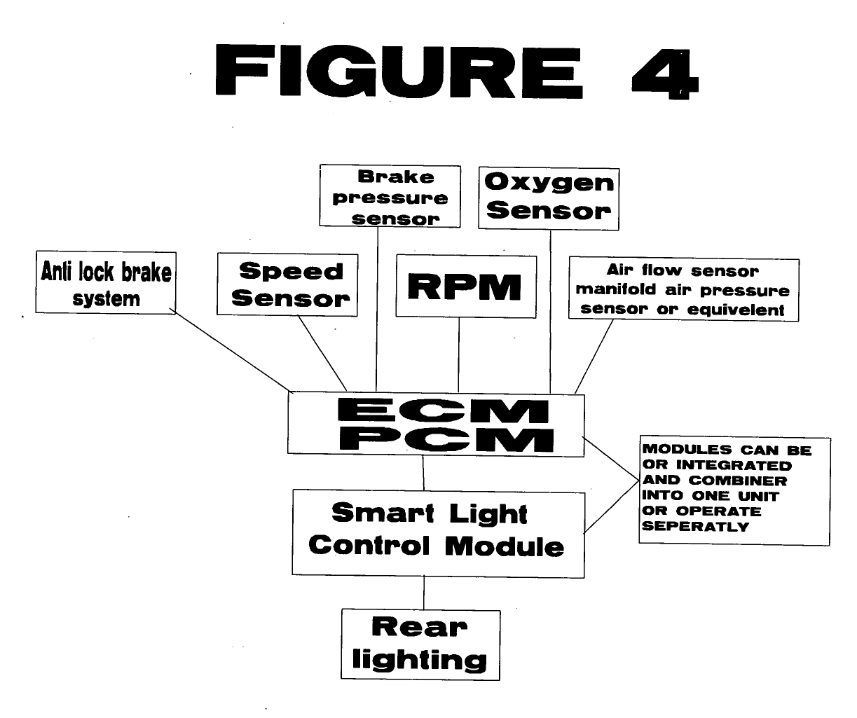

Turning to FIG. 4 it is shown a flow chart of the factory installed sensors used to comprise some or all of information needed to operate the invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A machine to provide a means for monitoring a motor vehicle operators actions and reactions to driving condition as they drive and alert other drivers behind them of their braking, coasting and accelerating actions with a multi function lighting device comprising:
A computerized light control module that will analyze information from the vehicles on board factory or added computer electrical, mechanical and/or braking system and display it's information in a lighted form on the rear of the motor vehicle; and
A light output source with the ability to output multi colors and/or light intensity such as, (bright green, green, amber, red, bright red, pulsating red) when signaled from the light control module.
